(19) United States
(12) Patent Application Publication
(10) Pub. No.: US 2026/0138524 A1
(43) Pub. Date: May 21, 2026

(54) LIGHTING DEVICE FOR A DOOR ENTRANCE AND VEHICLE BODY THEREFORE

(71) Applicant: HELLA GMBH & CO. KGAA, Lippstadt (DE)

(72) Inventors: Julian Grote, Borchen (DE); Carsten Hohmann, Warstein (DE); Marc Kaup, Paderborn (DE); Martin Mügge, Geseke (DE)

(21) Appl. No.: 19/392,531

(22) Filed: Nov. 18, 2025

(30) Foreign Application Priority Data
Nov. 21, 2024 (DE) 102024134211.0

(51) Int. Cl. B60Q 1/32; B60Q 1/50; F21V 8/00

(52) U.S. Cl. CPC B60Q 1/324; B60Q 1/5035; G02B 6/006; G02B 6/0068

(57) ABSTRACT

The invention relates to a lighting device for a door entrance of a vehicle with a light module. The light module includes a flat cover element having a light-permeable surface region and/or a light-impermeable surface region for forming a graphic pattern, and a flat light element which is configured to emit light from a front side of the light element facing the cover element in the direction of the flat cover element. The light module is designed in the shape of a strip, so that it is integrated in a door sill of the vehicle or on a lower edge of a door of the vehicle. The light module forms a visible surface of the door sill and/or of the lower edge of the door.

### CROSS-REFERENCE TO RELATED APPLICATIONS

The present application claims the benefit of German Patent Application DE 10-2024-134-211.0, filed Nov. 21, 2024, the disclosure of which is incorporated by reference.

### FIELD OF THE INVENTION

The invention relates to a lighting device for a door entrance of a vehicle with a light module having a flat cover element having a light-permeable surface region and/or a light-impermeable surface region for forming a graphic pattern, a flat light element which is configured to emit light in the direction of the flat cover element from a front side of the light element facing the cover element. Furthermore, the present invention relates to a vehicle body for such a lighting device.

### BACKGROUND OF THE INVENTION

From DE 10-2021-122-264 A1, a lighting device for a vehicle that comprises a light module with a liquid crystal display is known, which can be used to display light functions such as brake lights and indicator lights as well as light animations (welcome/goodbye) and battery charge level indicators of an electric vehicle. The lighting device is not intended for a door entrance area.

From DE 10-2021-104-643 A1, a lighting device for a door entry of a vehicle is known, in which a light module is formed by a hologram element arranged in an entry strip of the vehicle. A disadvantage of the known lighting device is that a light source must be arranged remotely from the flat light element integrated in the door strip. Furthermore, the light element is only visible when the vehicle door is opened.

A lighting device for a door entrance is known from EP 3802218 B1, which comprises a light module integrated into the door entrance. The light module is designed in a multi-layered fashion and consists of a cover element on the front side, which has light-impermeable and light-permeable surface regions to form a graphic pattern. A transparent plastic layer is attached to the cover element, which is molded onto the back of the cover element. The transparent plastic layer engages in openings in the cover element so that it is arranged flush with a front side of the cover element within the opening. A flat light guide is attached to the back of the plastic layer, at one narrow side of which a light source for in-coupling of light into the light guide is provided. The flat light guide has opposing flat sides for transmitting the in-coupled light within the light guide. A mirror layer is provided on one side of the light guide facing away from the cover element, by means of which the light coupled into the light guide is reflected in the direction of the front, i.e. in the direction of the cover element. For this purpose, an air gap is provided between the light guide and the mirror layer. A corresponding air gap is provided between the light guide and the plastic layer. A disadvantage of the known lighting device is that it has a relatively complex layered structure.

### SUMMARY OF THE INVENTION

The object of the present invention is to further develop a lighting device for a door entry of a vehicle and a vehicle body in such a way that the functionality of a lighting device in a door entrance area is improved with little effort.

To solve this problem, the invention, in connection with the generic term of the current embodiments, is characterized in that the light module is designed in the form of a strip, so that it is integrated into a door sill of the vehicle or on a lower edge of a door of the vehicle, wherein the light module forms a visible surface of the door sill and/or the lower edge of the door.

The particular advantage of the invention is that a light module is designed in has a relatively simple and flat design. On the one hand, it consists of a flat light element that emits light over a wide area on one front side. A flat cover element arranged at the front side with light-impermeable surface regions and light-permeable surface regions can be used to create a predefined graphic pattern. The light module is designed in the shape of a strip so that it is inserted into a door sill of the vehicle, which extends below a door of the vehicle, or so that it is arranged on the outside at a lower edge of the door. Advantageously, the light module can be activated independently of a closed or open state of the door of the vehicle. Advantageously, the light module can thus be permanently activated while the vehicle is in operation, so that predetermined light graphics or graphic patterns and/or additional signal light functions can be generated in a lower edge region of the vehicle body between the front wheels and rear wheels.

According to a preferred embodiment of the invention, a flat light element of the light module is designed as a flat light guide which has parallel opposing flat sides on which in-coupled light can be totally reflected in the light guiding direction. One or more light sources are arranged on a narrow side so that light can be coupled into the flat light guide via the narrow side facing the light source. The flat light guide itself has out-coupling means so that in-coupled light is deflected in the direction of the front side (light out-coupling surface) of the flat light guide facing the cover element. For example, a rear side of the flat light guide opposite the front side can be provided with an optical structure. Advantageously, the flat light guide enables a relatively flat design in the range of 6 mm, so that it can be integrated into a door sill or a lower edge of the door.

According to a further development of the invention, the flat light element is designed as a plurality of individually controllable light sources, which are covered on the front by a light-permeable optical disk as a cover element. Both components form a display. A specific light graphic or logo can be created by individually controlling the light sources.

According to a further development of the invention, the display is designed as a liquid crystal display. Preferably, the liquid crystal display is designed as a passive liquid crystal display, also known as a SmartGlass display. The liquid crystals are doped with color pigments and enclosed between two substrate layers, in particular thin glass panes or plastic films, which have an electrically conductive layer. This has the advantage of increasing transmission, as no polarization filter is required.

According to a further development of the invention, the light element is arranged directly butting the cover element. This creates a compact, flat light module.

According to a further development, the cover element is designed as a two-component cover pane with a light-impermeable first component and a light-permeable second component. The cover element thus serves as a screen or masking, while the light element provides homogeneous, flat light emission.

According to an alternative embodiment of the invention, the cover element is designed as a cover printing or as a cover film which is applied to the front of the light element or to a transparent lens, wherein the lens together with the cover printing or the cover film forms the cover element. The advantage of this is that the light module has a reduced overall depth.

According to a further development of the invention, the light module is designed as segmented in the longitudinal direction thereof, wherein a plurality of light element segments are arranged next to each other. These light element segments can be controlled independently of each other so that different lighting functions can be generated over the length of the light module. For example, a welcome and farewell animation can be integrated into one light element segment, while only the vehicle manufacturer's logo is displayed in another light element segment. For example, the charge level indicator of the battery of an electric vehicle can also be displayed if the light element segment is generated with the inclusion of a battery status signal. This can be done by means of a scale or a label. Advantageously, this segmented light module enables the display of different illuminated surfaces, which are particularly relevant when the driver gets into or out of the vehicle.

According to a further development of the invention, a light element segment or a light element is designed as an additional side indicator light element, the light-emitting surface of which is aligned in such a way that a turning light is emitted in a rearward acute or obtuse angle range in relation to a direction of travel of the vehicle. The advantage of this is that a signal function can also be made visible to the side or from a side position of the vehicle to the rear when the vehicle is turning or changing lanes.

Further advantages of the invention result from the embodiments disclosed herein.

### BRIEF DESCRIPTION OF THE DRAWINGS

Exemplary embodiments of the invention are explained in more detail in the figures below. In the figures:

FIG. 1 is side view of a vehicle body with a door sill in which a light module is integrated according to a first embodiment;

FIG. 2 is an enlarged depiction of the light module according to FIG. 1;

FIG. 3 is a side depiction of the body of the vehicle with a light module integrated in the door sill according to a second embodiment;

FIG. 4 is a side depiction of the body of the vehicle with a light module integrated into the door sill according to a third embodiment;

FIG. 5 is an enlarged depiction of the light module according to FIG. 4;

FIG. 6 is a side depiction of the body of the vehicle seen from the rear, wherein a light module is integrated in the door sill, which is designed as an additional side indicator;

FIG. 7 is a side depiction of the body of the vehicle with the door sill, in which a plurality of light modules are arranged;

FIG. 8 is a top view of a light module comprising a flat light guide;

FIG. 9 is a side depiction of the light module according to FIG. 8;

FIG. 10 is a perspective depiction of the light module according to FIG. 8;

FIG. 11 is a vertical section through a driver's door of the vehicle and through the door sill of the vehicle, wherein the light module is integrated in the door sill;

FIG. 12 is a side depiction of the body of the vehicle, wherein a light module is arranged in a lower edge region of a front door and a rear door; and

FIG. 13 is a vertical section through the door and the door sill according to FIG. 12.

### DETAILED DESCRIPTION OF THE CURRENT EMBODIMENTS

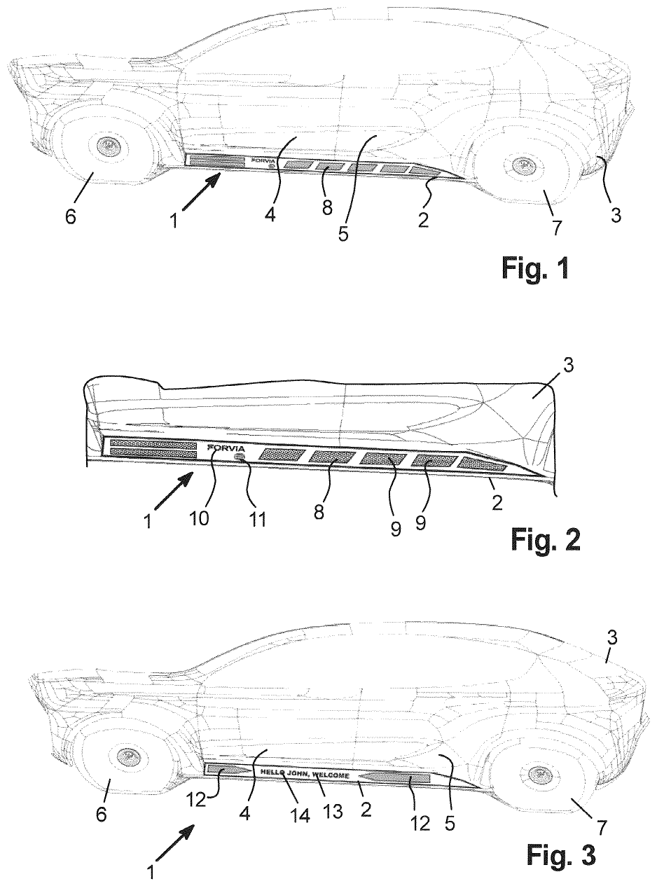

A lighting device for a door entrance of a vehicle has a light module 1 which, according to a first exemplary embodiment of the invention according to FIGS. 1 and 2, is integrated in a door sill 2 of a vehicle body 3 of the vehicle.

The door sill 2 extends below a front door 4 and a rear door 5 of the vehicle body 3 or the vehicle and is visible from the outside at all times, regardless of the opening and closing state of the doors 4, 5. The door sill 2 and thus also the light module 1 extend continuously between the wheel arches of the vehicle body 3, in which a front wheel 6 and a rear wheel 7 of the vehicle are located.

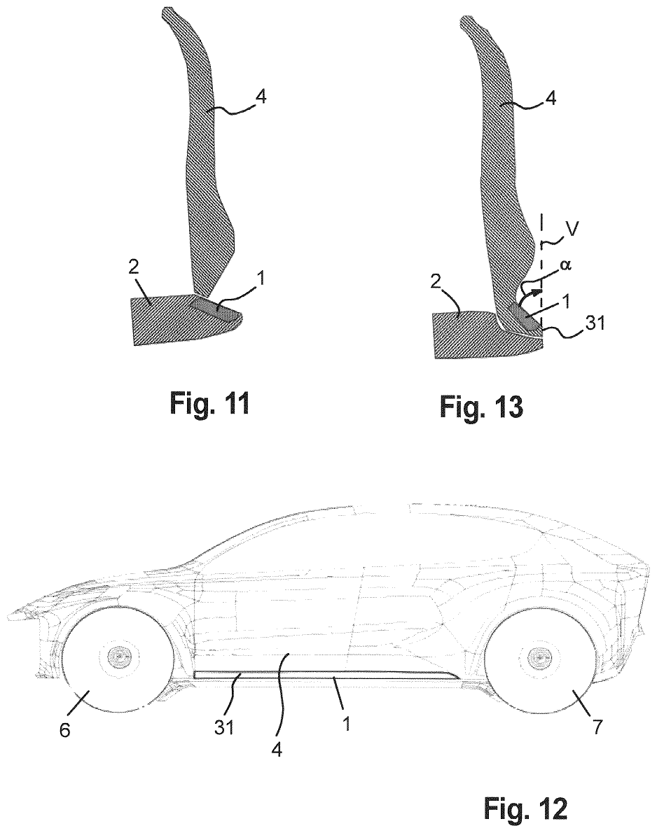

From the vertical section in FIG. 11, it can be seen that the light module 1 is located in an edge region of the door sill 2 that is not covered by the front door 4 or rear door 5. The light module 1 is fastened in a recess in the door sill 2 and preferably extends with one front side of the same flush with a surface of the door sill 2.

The light module 1 thus makes it possible to illuminate a visible surface of the door sill 2 or a non-concealed illuminated surface of the door sill 2.

The light module 1 can be designed as a liquid crystal display (LC display), which is disclosed in DE 10 2021 122 264 A1. This display has a light source, in particular an LED light source, and a liquid crystal field with individually controllable liquid crystal elements, so that a light graphic 8 (graphic pattern) with, for example, a plurality of rectangular illuminated surfaces 9 and a label 10 with the letters “FORVIA” and a logo 11 is displayed.

According to an alternative embodiment of the invention that is not depicted, the liquid crystal display can be designed as a liquid crystal display doped with color pigments, which is referred to as a SmartGlass display or passive liquid crystal display. Said display has two substrate layers, for example thin glass panes or plastic films, which have an electrically conductive layer and between which liquid crystals doped with color pigments extend. Unlike other liquid crystal displays, a polarization filter is not required.

According to a further embodiment of the invention according to FIG. 3, the light module 1 can be controlled in such a way that a welcome and farewell animation 13 is generated in addition to illuminated surfaces 12, which generates the lettering 14 with “HELLO JOHN, WELCOME” when the vehicle is opened, for example by means of a remote control, and generates the lettering “Goodbye John” when the vehicle is closed. The personalization of the greeting and farewell depends on the driver's user-dependent settings, such as the seat adjustment or the cockpit appearance. To do this, the driver uses a menu in the cockpit to set or personalize various functions of the vehicle to suit their needs.

According to an alternative embodiment of the invention, which is not depicted, the light module 1 can display a charge level indicator for the battery charge, in particular for electrically powered vehicles, so that the driver is informed of the current charge level when entering or leaving the vehicle.

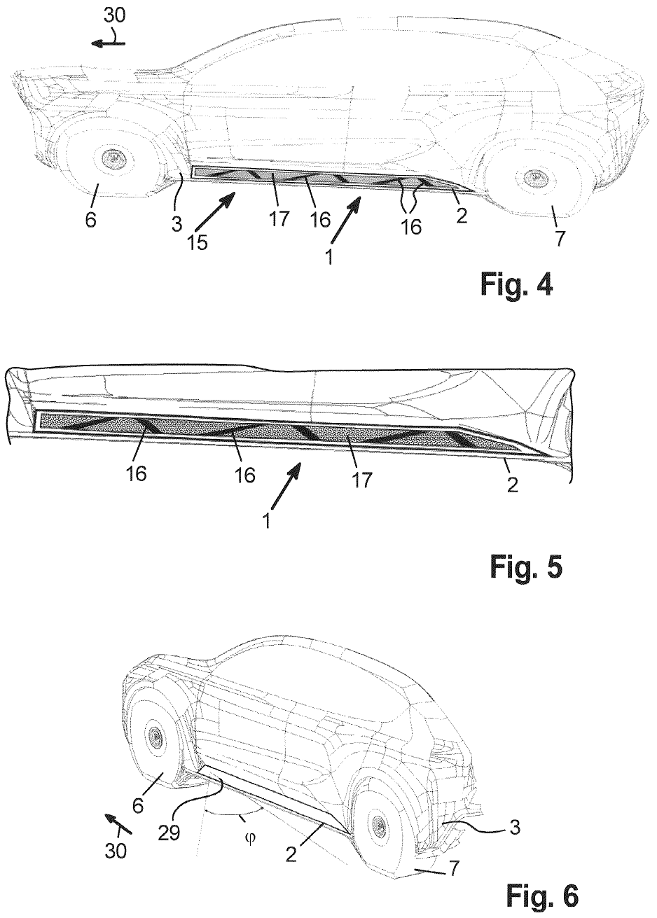

According to a further embodiment of the invention according to FIGS. 4 and 5, the light module 1 is designed such that it generates a light graphic 15 with a plurality of diagonal stripes 16 and a background surface 17. The diagonal stripes 16 have a different color than the background surface 17. In this version, the light module 1 can be designed as a liquid crystal display.

Alternatively, the light module 1 can also be designed as a display, in which the plurality of LED light sources are covered with a transparent optical pane as a cover element, which can have scattering elements if needed. The at least one light source can be designed as a monochrome LED light source or as a multicolored LED light source, for example an RGB light source.

If the light sources are RGB light sources, they can be controlled in such a way that different light animations are generated. For example, the rectangles or other geometric shapes can be created in different colors, such as in the color of the vehicle manufacturer. In addition, the lettering of the vehicle model or manufacturer can be displayed.

According to an alternative embodiment of the light module 1, it can have a flat light guide 18, which is covered on the front side by a flat cover element 19. In FIGS. 8 to 10, a flat light guide 18 is depicted by way of example, which has opposing flat sides 20, 20′ on which coupled-in light is totally reflected in a light guiding direction 21 and transmitted, wherein the flat sides 20, 20′ are connected to one another via narrow sides 22. An in-coupling of light takes place at a light in-coupling narrow side 22′ of the light guide 18, on which a plurality of light sources are preferably located along the narrow side 22.

The light guide 18 has out-coupling means, which are not depicted, so that the in-coupled light is deflected in the direction of the front side of the light guide 18, which serves as the light out-coupling surface 20′. The out-coupling elements can be prism-shaped optical elements, for example, which are arranged on the rear flat side 20 of the light guide 18 opposite the light out-coupling surface 20′. Alternatively, the out-coupling elements can be arranged within the light guide 18 or on the light out-coupling surface 20′ itself.

The flat sides 20, 20′ of the light guide 18 run parallel to each other.

The distance between the flat sides 20, 20′ can be in a range between 5 mm and 10 mm, for example 6 mm.

The flat light guide 18 forms a flat light element that emits light from its light out-coupling surface 20′ in the direction of the flat cover element 19. In the present exemplary embodiment, the flat cover element 19 has a plurality of openings 23 through which the light emitted by the light guide 18 can pass.

Alternatively, the cover element 19 can be designed as a continuous cover pane (two-component cover pane) with a light-impermeable or opaque first component and a light-permeable second component, which is produced by two-component injection molding. For example, the light-impermeable first component can be designed opaque, while the light-permeable second component is designed crystal clear. The first component forms a light-impermeable or opaque surface region of the cover element, while the light-permeable second component forms a light-permeable surface region of the cover element 19.

The at least one light source, which is associated with the flat light guide 18 or the light in-coupling narrow side 22′ thereof, can be designed as a monochrome LED light source or as a multicolored LED light source, for example RGB light source.

As can be seen from FIGS. 8 to 10, the flat light guide 18 abuts directly against the cover element 19.

According to an alternative embodiment of the invention that is not depicted, the cover element 19 can be designed as a cover printing or as a cover film, so that the overall depth of the light module 1 can be further reduced. Preferably, the cover printing or cover film is applied to the front side or light out-coupling surface 20′ of the flat light guide 18. If the cover printing or the cover film is applied to a crystal-clear lens, the cover element 19 is formed by the lens and the cover printing or cover film. The lens of the cover element 19 abuts flat against the front side or light out-coupling surface 20′ of the flat light guide 18.

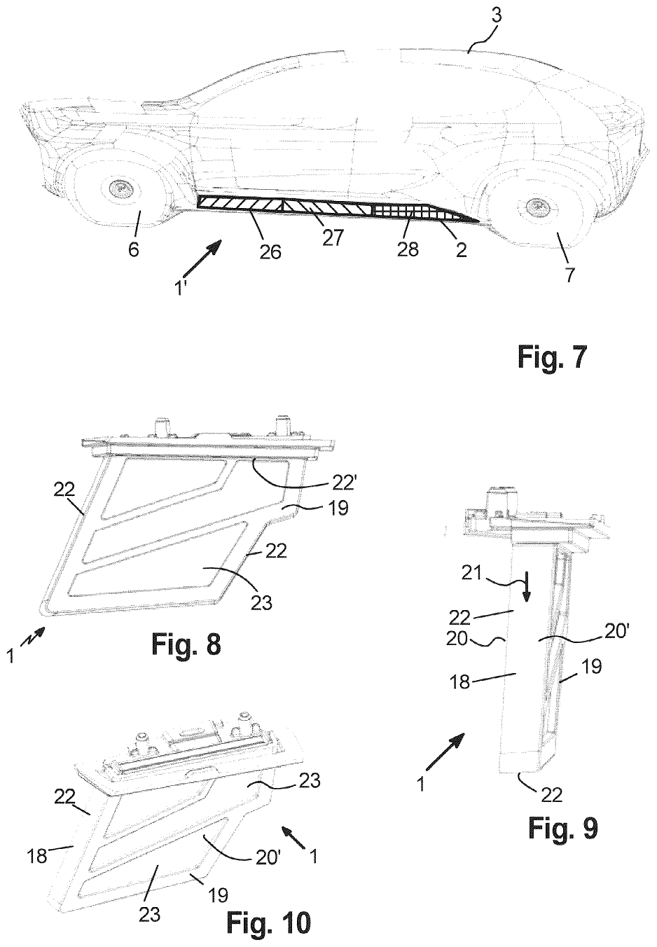

According to a further embodiment of the invention according to FIG. 7, a light module 1′ is designed as segmented with a plurality of light element segments 26, 27, 28. The light element segments 26, 27, 28 are arranged next to each other and together form the light module 1', which, like the light modules 1 of the previous embodiments, is designed strip-shaped or elongated. The light element segments 26, 27, 28 can be controlled independently of each other and can be of the same or different design. For example, the first light element segment 26 can be an LC display and the second light element segment 27 and the third light element segment 28 can each comprise a flat light guide 18. The different structure of the light element segments 26, 27, 28 allows different graphic patterns or graphic functions to be generated in a simplified manner.

According to a further embodiment of the invention according to FIG. 6, the light module 1 can be designed as an additional side indicator light element 29, which is used to signal a side indicator light when the vehicle is turning. For example, the at least one light source can emit light of yellow light color, while the cover element 19 is designed homogeneous, opaque or crystal clear, so that when the light source of the light module 29 thus formed is activated, a yellow illuminated surface appears periodically at the front and rear of the vehicle in synchronization with the turning lights. The light source of the additional side indicator light element 29 is thus switched on and off synchronously with the light sources of the turning light at the front and rear of the vehicle.

The fact that the door sill 2 slopes at an angle to an outer edge of it, see FIG. 11, means that the yellow light color of the additional side indicator light element can be emitted in a rearward acute or obtuse angle range φ in relation to a direction of travel 30.

The additional side indicator light element 29 can be arranged in a front region of the door sill 2 or continuously over the entire length of the door sill 2.

If the additional side indicator light element 29 is only arranged in a front region or front zone of the door sill 2, a light animation or other display functions can be provided in the at least one rear region or zone by corresponding light element segments 27, 28.

According to a further embodiment of the invention according to FIGS. 12 and 13, the light module 1 is integrated or arranged in a lower edge 31 of the front door 4 and the rear door 5. The lower edge 31 of the doors 4, 5 is designed as bent, resulting in a strip-shaped surface at an angle α to a vertical surface V. The light module 1 is arranged in this sloped area of the door 4, 5, so that light can be emitted to the side or diagonally upwards to the side via the front side of the light module 1. Since the light module 1 is located on an outer side φ of the door 4, 5, the light module 1 is visible to a person from the outside regardless of the opening/closing state of the door 4, 5.

According to an alternative embodiment that is not depicted, the strip-shaped light module 1, 1′ can also be designed shorter, for example extending only in one region of the front door 4.

It is understood that the flat cover element of the LED display or LC display is formed by the transparent cover pane or transparent substrate film. The flat cover element covers the light element that is arranged flat, which can be designed as a flat light guide or as a matrix-like array of light elements or light sources. The light guide or the light sources are used to generate the illuminated surface, while the cover element forms the front side end of the light module 1, 1′. The cover element 19 can consist of different areas with different degrees of transmission over the entire surface. Alternatively, it can also have openings so that light emitted from the front side of the light guide can be emitted directly into the surroundings.

### LIST OF REFERENCE SYMBOLS

1.1′ light module
2 door sill
3 vehicle body
4 front door
5 rear door
6 front wheel
7 rear wheel
8 light graphic
9 illuminated surfaces
10 label
11 logo
12 illuminated surfaces
13 welcome and farewell animation
14 lettering
15 light graphic
16 diagonal stripes
17 background surface
18 flat light guide
19 cover element
20.20′ flat sides
21 light guiding direction
22.22′ narrow sides
23 openings
26 light element segments
27 light element segments
28 light element segments
29 additional side indicator light element
30 direction of travel
31 edge
32 outer side
φ angle range
α angle

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A lighting device for a door entrance of a vehicle with a light module comprising:
a flat cover element comprising at least one of a light-permeable surface region and a light-impermeable surface region for forming a graphic pattern; and
a flat light element which is configured to emit light from a front side of the light element facing the cover element in a direction of the flat cover element;
wherein the light module is in the form of a strip, so that it is integrated in a door sill of the vehicle or on a lower edge of a door of the vehicle, wherein the light module forms a visible surface of the door sill or of the lower edge of the door.

2. The lighting device according to claim 1, wherein the flat light element is as a flat light guide which has parallel opposing flat sides on which coupled-in light from a LED light source can be totally reflected in order to transmit the same in a light guiding direction which runs in an extension plane of the flat light guide, wherein the flat sides are connected to one another via narrow sides, and wherein a narrow side of the flat light guide facing a light source is a light coupling surface, and wherein the flat light guide is configured to deflect the coupled light in the direction of the front side of the light guide serving as a light output surface for the light guide.

3. The lighting device according to claim 1, wherein the flat light element is a display with a plurality of individually controllable light sources which are covered on the front side by a light-permeable optical pane.

4. The lighting device according to claim 3, wherein the display is a liquid crystal display.

5. The lighting device according to claim 4, wherein the liquid crystal display is a passive liquid crystal display.

6. The lighting device according to claim 1, wherein the light element directly abuts the cover element.

7. The lighting device according to claim 1, wherein the cover element is a two-component cover pane with a light-impermeable or opaque first material component and with a light-permeable second material component.

8. The lighting device according to claim 1, wherein the cover element is a cover printing or as a cover film which is applied to the front side of the light element or to the front side of a transparent lens, wherein the lens forms the cover element together with the cover printing or together with the cover film.

9. The lighting device according to claim 1, wherein the light module has a plurality of light element segments which extend in the longitudinal direction thereof and are arranged next to one another in the longitudinal direction of the light module, wherein the plurality of light element segments are controllable independently of one another.

10. The lighting device according to claim 1, wherein a light element or a light element segment is an additional side indicator light element, a light-emitting surface of which is aligned in such a way that a side indicator light is emitted in a rearward acute or obtuse angle range with respect to a direction of travel of the vehicle.

11. The lighting device according to claim 10, wherein the additional side indicator light element is arranged as an additional side indicator light segment in a front region of the door sill and/or the door as seen in the direction of travel.

12. The lighting device according to claim 10, wherein a light animation segment, by which a light animation can be generated, is connected to the additional side indicator light segment in the opposite direction to the direction of travel.

13. The lighting device according to claim 12, wherein the light animation segment is controlled in such a way that a welcome graphic and/or a farewell graphic is generated as a function of an opening/closing state of the door.

14. The lighting device according to claim 1, wherein the light element is configured to display at least one of: a charge state indicator of a battery of the vehicle; a representation of a locking state of the vehicle; and a logo.

15. A vehicle body comprising a door sill or a door with the lighting device of claim 1.
